(19) United States
(12) Patent Application Publication
(10) Pub. No.: US 2011/0130513 A1
(43) Pub. Date: Jun. 2, 2011

(54) Method for producing bead-shaped polylactide pellets

(75) Inventors: Heng-Bo Chiang, Taichung (TW); Chen-Pao Huang, Taichung (TW)

(73) Assignee: CHI-MEI CORPORATION

(21) Appl. No.: 12/926,573

(22) Filed: Nov. 26, 2010

(30) Foreign Application Priority Data
Dec. 2, 2009 (TW) 098141246

(51) Int. Cl. C08L 67/04; B29B 9/16

(52) U.S. Cl. 524/599; 264/5

(57) ABSTRACT

The present invention relates to a method for producing a bead-shaped polylactide pellets and the bead-shaped polylactide pellets prepared from the method thereof, and primarily includes an die-face cutting step, a dewatering step and a crystallization step. In which bead-shaped polylactide pellets are produced from a polylactide melt undergoing the die-face cutting step, the dewatering step and the crystallization step. The die-face cutting step is carried out by immersing the polylactide melt in water at a temperature of 50° C.˜90° C.; the dewatering step is carried out in an atmosphere temperature of 80° C.˜150° C.; the crystallization step is carried out in an atmosphere temperature 80° C.˜150° C. The bead-shaped polylactide pellets obtained have a water content of 10˜400 ppm, and smooth surfaces with no concave. The producing method of the present invention is thus able to achieve the objective of saving mass energy consumption.

### BACKGROUND OF THE INVENTION

(a) Field of the Invention

The present invention relates to bead-shaped polylactide pellets and a manufacturing method thereof. More particularly the present invention relates to a production method that prevents polylactide pellets from easily agglomerating during the production process.

(b) Description of the Prior Art

Polylactide can be produced by the process of polymerization of lactic acid (abbreviated as LA) to form lactic acid oligomer, decomposition thereof to form lactide, and then ring-opening polymerization of lactide. Such a polymer is biodegradable, and will be the main product of plastics of environmental protection. In addition, polylactide can also be produced by direct polycondensation of lactic acid. However it is difficult to obtain polylactide from such a polymerization method.

In general, the polylactide is obtained by carrying out ring-opening polymerization of a combination of monomers of chiral substances, including L-lactide, D-lactide or Meso-lactide . . . etc., with an adequate amount of catalyst present. After polymerization the polylactide pellets are obtained through the steps of melt extrusion, pelletization and crystallization.

In a well-known method of manufacturing polylactide pellets, the polylactide is prepared by the polymerization of lactide and extruded by an extruding device (for example an extruder or a gear pump) at a temperature of approximately 190° C. The melt of polylactide is extruded into strands and cooled in a cooling water bath (water temperature is approximately 10° C. to room temperature). After leaving the cooling water bath a part of water adhered on the strands is removed by blowers and the strands are pelletized. If necessary, the pellets can further be subjected to a crystallization step to crystallize and/or dry the polylactide. The shape of pellets obtained by this method is cylindrical. However, the problem of agglomeration of the cylindrical-like polylactide pellets frequently occurs when carrying out the following crystallization and/or drying steps, making the production difficult. In another aspect, the water content of the polylactide pellets obtained after the crystallization step is very high (approximately more than 800 ppm), and the pellets generally require further drying in order to reduce the hydrolysis of the polylactide. Accordingly, such production method results in mass energy consumption. More specifically, the process of rapid cooling from the high temperature of melt to a low temperature and then raising the temperature again results in mass energy consumption.

Another well known manufacturing method of polylactide pellets is similar to the aforementioned manufacturing method except that the outlet of a die used to extrude the polymer melt is positioned underwater, and the water is at a low temperature (such as 10° C.). The polymer melt is immediately cut into pellets by cutters outside the outlet of the die when extruded therefrom, and crystallization and/or drying can be further carried out depending on needs. The appearance of the pellets obtained by such a manufacturing method is slightly bead-shaped. However, referring to FIG. 9, which shows a concave 81 in the surface of a pellet 80 obtained by this method, the problem of agglomeration easily occurs when carrying out subsequent drying and/or crystallization, resulting in production difficulties. In another aspect, water content of the polylactide pellets obtained by this method is very high after the crystallization step (approximately more than 600 ppm), and the pellets generally require further drying in order to reduce the occurrence of hydrolysis of the polylactide. Accordingly, such a manufacturing method results in mass consumption of energy resources. More specifically, the process of rapid cooling from the high temperature of melt to a low temperature and then raising the temperature again results in wastage of large amounts of energy resources.

### SUMMARY OF THE INVENTION

In order to resolve the aforementioned problems of the prior arts, the inventor of the present invention, after determined and dauntless research, provides methods for manufacturing polylactide pellets of low water content and which do not easily agglomerate during preparation. The present invention also achieves the objective of reducing wastage of energy resources. Furthermore, the bead-shaped polylactide pellets obtained by the present invention have smooth surfaces with no concaves.

The present invention, therefore, provides a method for producing a bead-shaped polylactide pellets, comprising a die-face cutting step, a dewatering step and a crystallization step, wherein the die-face cutting step is carried out by immersing the melt of polylactide under water at a temperature of 50˜90° C.; the dewatering step is carried out in an atmosphere at a temperature between 80˜150° C.; the crystallization step is carried out in an atmosphere at a temperature between 80˜150° C.; the bead-shaped pellets finally obtained have a water content of 10˜400 ppm; and the bead-shaped pellets have smooth surfaces with no concaves.

### BRIEF DESCRIPTION OF THE TABLE

Table 1 is the Examples and Comparative Examples of a method for manufacturing polylactide pellets of the present invention.

### BRIEF DESCRIPTION OF THE DRAWINGS

FIG. 1 is a flow chart representation of the method for producing polylactide pellets according to the present invention,

FIG. 2 is a schematic representation of cutters and a die immersed in water of the die-face cutting step of the present invention,

FIG. 3 is a sectional schematic representation of an outlet portion of the die in the die-face cutting step of the present invention,

FIG. 4 is a schematic representation of a vibrating conveyor used in the crystallization step of the present invention,

FIG. 5 is a schematic representation of a silo bin used in the crystallization step of the present invention,

FIG. 6 is a schematic representation of a continuous fluidized bed used in the crystallization step of the present invention,

FIG. 7 is a schematic representation of the state of an exposed portion of an IR Drum used in the crystallization step of the present invention,

FIG. 8 is a schematic representation of a pellet produced by the method of the present invention provided with a smooth surface having no concave, and

FIG. 9 is a schematic representation of the surface of a pellet containing a concave.

### DETAILED DESCRIPTION OF THE PREFERRED EMBODIMENTS

It is of course to be understood that the embodiments described herein are merely illustrative of the principles of the invention and that a wide variety of modifications thereto may be effected by persons skilled in the art without departing from the spirit and scope of the invention as set forth in the following claims.

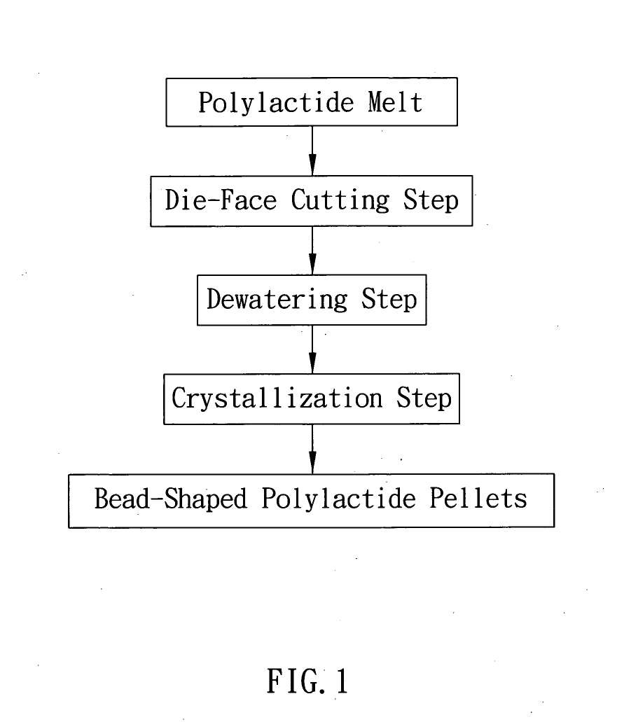

Referring to FIG. 1, the present invention provides a method for manufacturing polylactide pellets, and primarily comprises an die-face cutting step, a dewatering step and a crystallization step, wherein a melt of polylactide undergoes the die-face cutting step, the dewatering step and the crystallization step in order to manufacture the polylactide pellets.

The die-face cutting step is carried out by immersing the melt of polylactide in water at a temperature of 50˜90° C. The dewatering step is carried out in an atmosphere at a temperature between 80˜150° C. The crystallization step is carried out in an atmosphere at a temperature between 80˜150° C.

After the crystallization step, the water content of the bead-shaped polylactide pellets obtained by the manufacturing method of the present invention, is preferably 10˜400 ppm. A preferred embodiment of the bead-shaped polylactide pellets is the type of pellets which has a heat of crystallization of 2˜60 J/g as measured in the cooling stage by a differential scanning calorimeter, and the preferred degree of crystallization of the pellets is 30˜60%. Another preferred embodiment of the bead-shaped polylactide pellets obtained by the manufacturing method of the present invention is the type of pellets which has a heat of crystallization of ≧0 J/g and <2 J/g, and a degree of crystallization of ≧1% and <30% as measured in the cooling stage by a differential scanning calorimeter.

In addition, the preferred polylactide used in the manufacturing method of the present invention is prepared by polymerization of 100% by weight of starting material monomers containing 97˜99.95% by weight of L-lactide, with a preference given to polymerization of 100% by weight of starting material monomers containing 99˜99.95% by weight of L-lactide: Another embodiment of the polylactide used in the manufacturing method of the present invention is preferably prepared by polymerization of 100% by weight of starting material monomers containing 97˜99.95% by weight of D-lactide, more preferable is polylactide prepared by polymerization of 100% by weight of starting material monomers containing 99˜99.95% by weight of D-lactide. Yet another embodiment of the polylactide used in the manufacturing method of the present invention is based on a polylactide stereocomplex preferably formed from a mixture of 30˜95% by weight of poly(L-lactide) and 70˜5% by weight of poly(D-lactide).

The monomers used in the manufacture of the polylactide of the present invention include L-lactic acid, D-lactic acid, L-lactide formed from two L-lactic acids, D-lactide formed from two D-lactic acids, and Meso-lactide formed from L-lactic acid and D-lactic acid, as well as optional copolymerizable monomers. Specific examples of optional copolymerizable monomers include: succinic acid, adipic acid, azelaic acid, sebacic acid, Phthalic acid, isophthalic acid, terephthalic acid, ethylene glycol, 1,2-propylene glycol, 1,2-butylene glycol, 1,2-pentanediol, hexamethylene glycol, octanediol, Neopentyl glycol, and cyclohexanedimethanol, etc.

One of preferred major constituents used to produce the polylactide of the present invention are a combination of the aforementioned chiral substances, including L-lactide, D-lactide, and Meso-lactide. With an adequate amount of catalyst and optional chemical additives or solvent the polylactide is prepared by ring-opening polymerization. Examples of the catalyst used in the aforementioned polymerization include: oxides of metals from Groups IV, V, VIII of the Periodic table, halogenide or carboxylate; specific examples of which include: antimony trioxide (Sb₂O₃), stannous oxide (SnO), stannous dichloride (SnCl₂), and Stannous bis(2-ethylhexyl carboxylate) (Sn(Oct)₂). Dosage of the catalyst is determined based on the conditions of the polymerization reaction. The ratio by weight of the aforementioned lactide compound to the catalyst is 5,000:1˜100,000:1, preferably 10,000:1˜90,000:1, and more preferably 15,000:1˜80,000:1. There is no restriction on the type of the aforementioned chemical additives, and the types of chemical additives include antioxidants, dehydrating agents, and molecular weight regulators. There is no limit to the added amount of the chemical additives, the preferred amount making up 10˜50,000 ppm relative to the lactide, 50˜30,000 ppm being more preferable. The aforementioned chemical additives can be added before the polymerization reaction, during the polymerization reaction, or added to a extruder after devolatilization. In the present invention, in order to accelerate crystallization, crystal nucleating agents can be further added to the polylactide to form a melt, and generally speaking, adding crystal nucleating agents provides the advantages of causing polymer crystals to become smaller, and the rate of crystallization becomes faster. Specific examples of crystal nucleating agents include: talc, titanium dioxide (TiO₂) powder, calcium carbonate (CaCO₃) powder, boron nitride, aliphatic carboxylic acid amides, aromatic sulfonate derivatives, and zinc phenylphosphonate. Examples of the aforementioned solvent added to the polymerization include: ethyl benzene, toluene, ethyl hexane, acetone, and the like. The ring-opening polymerization equation is as follows:

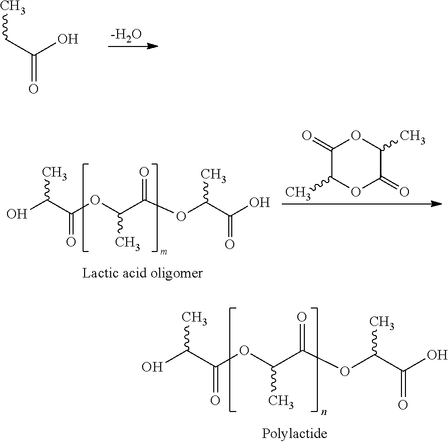

The polylactide of the present invention preferably uses a mixture of 100% by weight of starting material monomers containing 97˜99.95% by weight of L-lactide and other constituents, and more preferably 100% by weight of starting material monomers containing 99˜99.95% by weight of L-lactide and other constituents (for example, D-lactide or Meso-lactide). This enables obtaining poly(L-lactide) with a faster rate of crystallization to achieve the objective of the present invention. In another embodiment, the polylactide of the present invention can also preferably use a mixture of 100% by weight of starting material monomers containing 97˜99.95% by weight of D-lactide and other constituents, and more preferably 100% by weight of starting material monomers containing 99˜99.95% by weight of D-lactide and other constituents (for example, L-lactide or Meso-lactide). This enables obtaining polylactide with a faster rate of crystallization to achieve the objective of the present invention. In addition, the polylactide of the present invention can also use stereocomplex polylactide (SC-PLA) formed from a mixture of 30˜95% by weight of poly(L-lactide) and 70˜5% by weight of poly(D-lactide) to achieve the objective of the present invention. The number-average molecular weight of the polylactide used for the present invention is 40,000˜160,000.

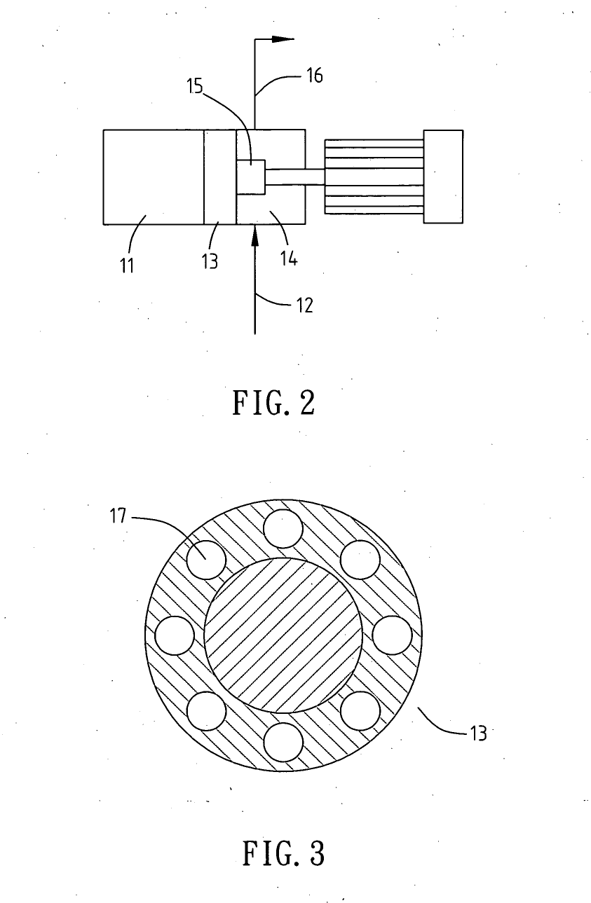

The melt of the polylactide of the present invention is formed by extruding the polylactide formed by polymerization of the aforementioned lactide compounds through an extrusion device, such as an extruder or Gear pump, at a temperature approximately between 160˜240° C. Referring to FIG. 2, which shows a gear pump fitted to a rear end of an extrusion device 11 (such as an extruder) sending the melt to a die 13. Referring to FIG. 3, which shows the outlet of the die 13 provided with a plurality of small holes 17, and the outlet of the die 13 is immersed in water 14. The melt passes through the small holes 17 in the outlet of the die 13 and enters the next die-face cutting step.

The die-face cutting step of the present invention is carried out on the polymer melt extruded through the aforementioned small holes 17 in the die 13, and is carried out in the water 14. The temperature of water is 50˜90° C., preferably 55˜85° C., and more preferably 60˜80° C. If the water temperature is too low (less than 50° C.), then the surfaces of the bead-shaped pellets manufactured are formed with concaves, and agglomeration of the pellets very easily results during the preparation, especially in subsequent drying and/or crystallization steps. Moreover, rapid cooling results because the water temperature is too low, making it difficult to drive out the water in the pellets, resulting in a relatively high water content in the pellets. And a relatively high water content causes hydrolysis of the polylactide. Hence, in general, a drying step must be further carried out, thereby resulting in the shortcoming of consuming even more energy resources. If the water temperature is too high (higher than 90° C.) when carrying out die-face cutting, then agglomeration of the produced pellets very easily results during the subsequent crystallization and/or drying steps. The so-called die-face cutting comprises immersing both the outlet of the die 13 and cutters 15 within the water 14, with the cutters 15 being close to and flat against the outlet of the die 13. The cutters 15 are used to continuously cut the melt as it is extruded from the outlet of the die 13 to form pellets. The die-face cutting of the present invention forms pellets having a bead-shaped appearance. The aforementioned water is able to flow, and a warm water supply 12 and a warm water outlet 16 are used to cause the water to flow and drive the pellets to the next dewatering step. There is no limit to the volume rate of flowing water, and is determined depending on needs. Taking a throughput capacity of 1 kg/hr of polylactide as an example, the flow rate of water is preferably 0.0167 m³/hr˜0.333 m³/hr, and taking a throughput capacity of 300 kg/hr of polylactide as an example, the flow rate of water is preferably 5 m³/hr˜100 m³/hr. The dewatering step of the present invention comprises removing water from the pellets (containing water) formed after undergoing the die-face cutting step in a dewatering device. Examples of a dewatering device include equipment such as: a centrifugal dryer, a vibrating screen, filter cloth, and the like. The dewatering step is carried out in an atmosphere temperature of 80˜150° C., the preferred temperature being 90˜130° C., and a more preferable temperature is 100˜120° C. Measurement of the aforementioned atmosphere temperature is obtained using a thermometer (such as: a thermocouple) disposed at the outlet of the dewatering device, the pellets and the thermometer being continuously in direct contact for short periods. The atmosphere temperature measured by the thermometer does not represent the actual surface temperature of the pellets in direct contact with the thermometer. Retention time of the pellets in the dewatering device depends on the amount of water to be removed, and the more the amount of water to be removed, the longer the retention time. Retention time of the pellets in the dewatering, device can be around 0.1˜50 minutes, a preferred retention time is 0.5˜30 minutes, and a retention time of 1˜20 minutes is more preferable. The water separated out in the aforementioned dewatering step contains trace amounts of polylactide chips, and clean water is obtained after filtering out the chips by passing through a filter. Warm water can be obtained by heating the clean water to 50˜90° C. using a heating device and sent to the aforementioned die-face cutting step for reuse thereof. After the aforementioned pellets have undergone the dewatering step, the completely dewatered pellets enter the next crystallization step.

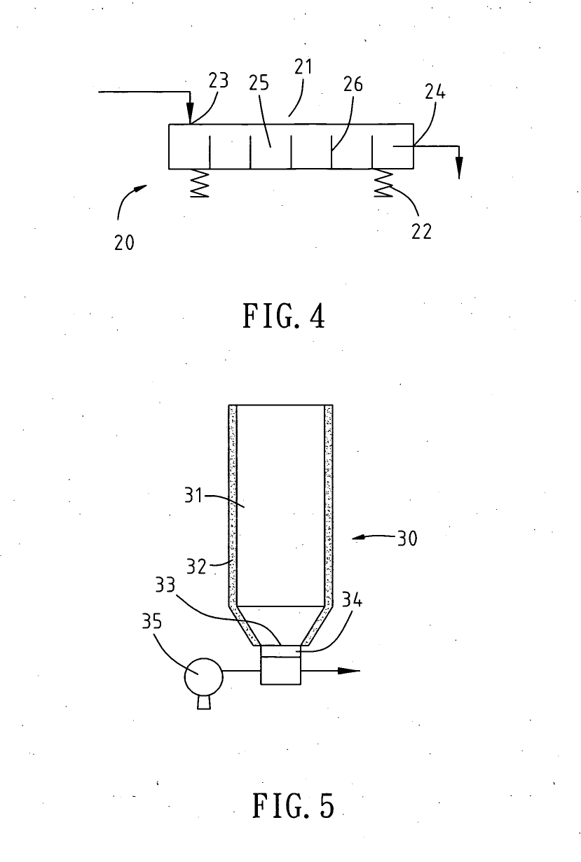

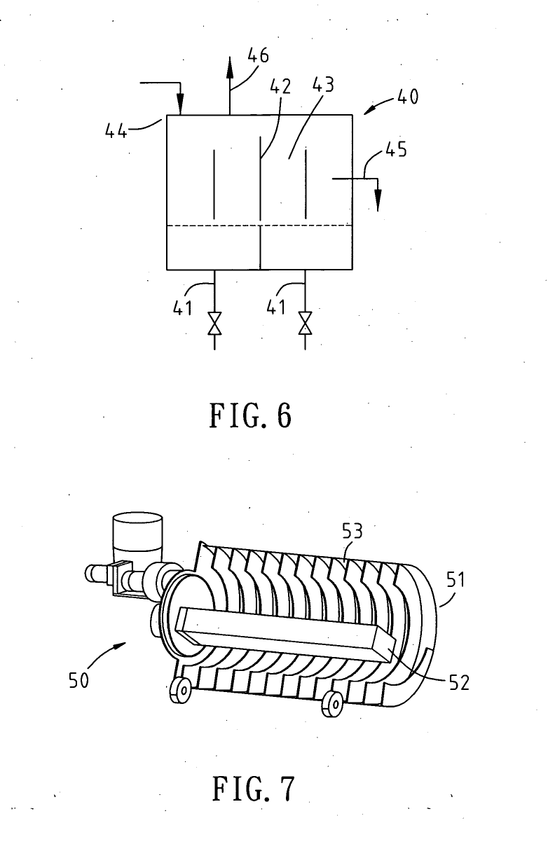

The crystallization step of the present invention is carried out in a crystallization device, and there are no special limitations on the crystallization device, specific examples include devices such as: a vibratory conveyor device, a silo bin, a continuous fluidized bed and an IR drum. Heating of the aforementioned crystallization device can be carried out using hot air, infrared rays or other heating devices depending on needs. Referring to FIG. 4, which shows a vibratory conveyor device 20 as mentioned above, comprising a conveyer 21 structured from a plurality of partitions 26 to separate the conveyer 21 into a plurality of holding chambers 25. Vibrators 22 are disposed beneath the conveyer 21, and polylactide pellets enter through an inlet 23 at one end of the conveyer 21. Vibration of the vibrators 22 causes the polylactide pellets 23 to jump forward over the partitions 26 from one holding chamber 25 toward another holding chamber 25, thereby gradually transporting the pellets forward to an outlet 24 at the other end of the conveyer 21. Referring to FIG. 5, which shows a silo bin 30 as mentioned above, primarily comprising a tank 31 designed to provide thermal insulation. The periphery of the tank 31 can be enclosed in a heat insulating layer 32 fabricated from thermal insulating material to achieve the objective of thermal insulation. The tank 31 is disposed in an upright position, and size of the internal volume of the tank 31 depends on the retention time of the pellets. The pellets enter the tank 31 from above, and the effect of gravity causes the pellets to gradually move from the upper portion toward the lower portion of the tank 31. A control device 34 (such as: a control valve) can be disposed at an outlet 33 of the tank 31 to control the rate of movement and discharge of the pellets. Moreover, an air supply device 35 is used to transport the pellets. Referring to FIG. 6, which shows a continuous fluidized bed 40 as mentioned above, in which hot air is blown in at a specific speed from a bottom portion of the fluidized bed 40, thereby causing the pellets to form a fluidized state. The continuous fluidized bed 40 is internally provided with a plurality of vertical partitions 42, which separate the continuous fluidized bed 40 into a plurality of holding chambers 43 (positioned in a transverse direction). A specific speed of hot air causes the polylactide pellets to flow from the holding chamber 43 closest to an inlet 44 of the fluidized bed 40 and pass beneath the partition 42 into another holding chamber 43, in this way the polylactide pellets are made to gradually flow from one after another of the holding chambers 43 into the last of the holding chambers 43 closest to an outlet 45 of the fluidized bed 40, after which the polylactide pellets spill out from the outlet 45 of the holding chamber 43. An upper portion of the fluidized bed is provided with a hot air outlet 46. Specific examples of a continuous fluidized bed include: the NARA continuous fluidized bed, model No. C-FBD-0.24, manufactured by Nara Machines. Furthermore, referring to FIG. 7, which shows an IR drum 50 comprising a transversely disposed vessel 51, wherein an infrared heating device 52 is disposed within the vessel 51 to serve as a heat source, and the inner wall of the vessel 51 is provided with thread grooves 53. Rotation of the vessel 51 is used to cause the polylactide pellets to move forward within the vessel 51 along the thread grooves 53.

The aforementioned crystallization step is carried out in an atmosphere at a temperature between 80˜150° C. For the poly(L-lactide) formed by polymerization of L-lactide or the poly(D-lactide) formed by polymerization of D-lactide, the preferred temperature of atmosphere is between 90˜140° C., and more preferably between 100˜130° C. For the stereocomplex polylactide, the preferred temperature of atmosphere is 100˜140° C., and more preferable between 110˜130° C. Measurement of the atmosphere temperature of the aforementioned crystallization step is obtained by thermometers being in direct contact with the polylactide pellets. A thermocouple can be chosen for use as the thermometer, more specifically, different atmosphere temperature measuring means are used according to different crystallization devices. Taking a silo bin as an example, the thermometers are placed within the tank, and the polylactide pellets flowing from the upper portion into the lower portion of the tank contact directly with the thermometer to enable measuring the atmosphere temperature of the crystallization step. The thermometers of a vibrating conveyer are placed in the chambers thereof. The pellets directly contact with the thermometers when jumping over the partitions and the atmosphere temperature of the crystallization step is obtained thereby. Whereas, the thermometers of the continuous fluidized bed are placed in the chambers between two partitions. The polylactide pellets in a fluidized state directly contact with the thermometer and the atmosphere temperature of the crystallization step is obtained thereby. The IR Drum is internally equipped with thermometer, and rotation of the vessel 51 is used to cause tumbling of the pellets within the vessel 51 to come in direct contact with the thermometers, thereby obtaining the atmosphere temperature of the crystallization step. However, the temperatures measured by the thermometers do not represent the surface temperature of the polylactide pellets in direct contact with the thermometers. The retention time of the aforementioned polylactide pellets in the crystallization step is 1˜50 minutes, a preferable retention time is 2˜40 minutes, and a more preferable retention time is 3˜30 minutes.

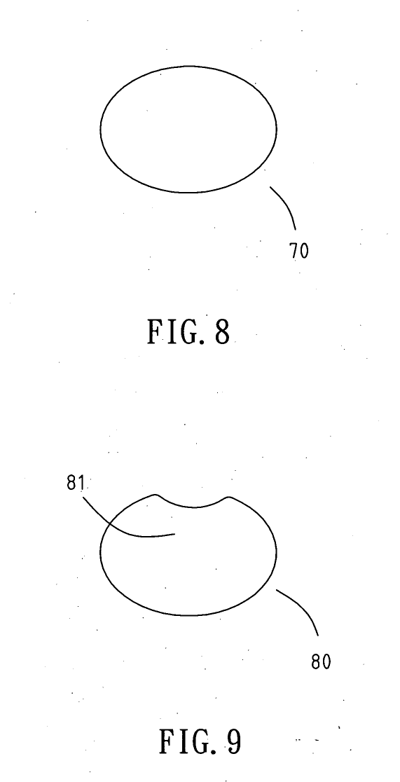

Referring to FIG. 8, which shows a bead-shaped polylactide pellet 70 produced by the present invention, and the appearance of the bead-shaped polylactide pellet 70 is similar to a spherical pellet, and is smooth with no concaves.

After the crystallization step, water content of the polylactide pellets manufactured by the method of the present invention is low. Preferred water content is 10˜400 ppm, more preferable is 50˜300 ppm, and preferred optimum water content is 80˜250 ppm. Sampling and analysis of the water content of the polylactide pellets is carried out immediately after the crystallization step. If the water content of the pellets is too high, then the polylactide is easy to hydrolyze in subsequent molding process. Thus it is often necessary for the polylactide containing an excessively high water content to undergo a further drying process This results in wastage of energy resources. The water content of the pellets manufactured by the manufacturing method of the present invention is relatively low, the reason for which is not clear. However, the inventor of the present invention conjectures that it is possibly because the melt extruded through the die is at a temperature of approximately 160˜240° C., whereas, the die-face cuffing step is carried out in warm water at a temperature of around 50˜90° C., thus, the pellets are able to moderately cool down, thereby resulting in the low water content thereof. Moreover, temperature distribution of the pellet is such that the temperature slowly decreased from the center of the pellet towards the surface of the pellet (non-rapid cooling), thus, the temperature difference between the center of the pellet and the surface thereof is not that large, hence, concaves are not formed on the surface of the pellets. In addition, because the polylactide pellets manufactured by the method of the present invention are provided with smooth surfaces with no concaves, thus, when the pellets are piled up, the resting angle of the pellets is relatively small, and the area of contact surface between the pellets is small. Hence, during the manufacturing process, especially during the dewatering and/or the crystallization step, the pellets do not easily agglomerate, and thus does not hinder production. Preferred particle diameter of the pellets manufactured by the present invention is 1 mm˜5 mm.

The polylactide pellets obtained after the crystallization step must still pass through a cooling stage. A natural cooling method or a forced cooling method can be chosen as the cooling means for the cooling stage to cause the pellets to release heat of crystallization. Thereby the temperature of pellets is lowered to facilitate subsequent packaging or storage. In one embodiment of the polylactide manufactured by the present invention, the preferred heat of crystallization of the pellets released in the aforementioned cooling stage, as determined using a differential scanning calorimeter, is 2˜60 J/g. A larger release of heat of crystallization released in the cooling stage represents a faster rate of crystallization, and the 2˜60 J/g of heat of crystallization released in the cooling stage represents a fast rate of crystallization of polymer. The preferred degree of crystallization of the polylactide manufactured by the aforementioned method is 30˜60%, more preferable is 35˜55%, and a preferred optimum degree of crystallization is 40˜50%. In the aforementioned method of manufacturing the polylactide having a fast crystallization rate and a high degree of crystallization, the crystallization device used in the crystallization step can include devices such as: a vibrating conveyer, a silo bin, a continuous fluidized bed and an IR drum.

Another preferred embodiment of the bead-shaped pellets of polylactide obtained by the production method of the present invention is the type of polylactide pellets such that the heat of crystallization released in the cooling stage, as measured by a differential scanning calorimeter, is ≧0 J/g and <2 J/g, and the preferred degree of crystallization of the polylactide pellets is ≧1% and <30%, and the more degree of crystallization of the polylactide pellets is 2%˜25%, and the best preferred degree of crystallization of the polylactide pellets is 3%˜20%. In the aforementioned method of manufacturing the polylactide having a low crystallization rate and a low degree of crystallization (or amorphous), the crystallization device used in the crystallization step can include devices such as: a vibrating conveyer, a continuous fluidized bed and an IR drum; that is, the crystallization device must be designed to provide external agitation, such as devices providing vibration, rotation or external blowing of air, but does not include silo bin which will cause the bead-shaped polylactide pellets to agglomerate during production process.

In the method of the present invention for manufacturing bead-shaped polylactide pellets, the temperature of the polymer melt extruded, at high temperature is approximately 160˜240° C., the die-face cutting step is carried out in warm water at a temperature of 50˜90° C., and the dewatering step and the crystallization step are carried out in an atmosphere at a temperature of 80˜150° C. Because the die-face cutting step in most of the prior art is carried out in a low to room temperature environment, thus, the temperature of the polylactide pellets is substantially decreased, and after die-face cutting step, the temperature is raised (to above 100° C.) to carry out crystallization, resulting in mass energy consumption. Whereas, in the present invention, the die-face cutting step is carried out in warm water at a temperature above 50° C., thus, the temperature of the polylactide pellets can be kept in the following crystallization step (such as 105° C.) for crystallization to be carry out directly, thereby eliminating the need for an additional energy supply, or only needing to supply a small amount of energy. Accordingly, the present invention is better to save energy.

The present invention will be further described by means of the following working examples, without intended to restrict the scope of the present invent thereto.
1. Inspection of the concaves of the polylactide pellets:
   Visually inspect whether the surfaces of the bead-shaped polylactide pellets are smooth and no concaves have formed.
   ∘: Represents that the surfaces of the pellets have no concaves
   X: Represents that the surfaces of the pellets have a concave
2. The heat of crystallization (rate of crystallization speed) of the polylactide released in the cooling stage measured by differential scanning calorimeter (DSC)
   Method of measurement:
   Using 10 milligrams of polylactide pellets as measured using a differential scanning calorimeter (an environment with nitrogen gas being passed through at a rate of 50 milliliters per minute), the temperature of the bead-shaped pellets is raised from 30° C. to X° C. at a rate of 10° C./min., and the temperature is then maintained for 5 minutes. The temperature is then lowered at a rate of 2° C./min. to enable the pellets to cool from X° C. to 30° C., and the heat of crystallization (J/g) released during the cooling stage of the polylactide pellets from X° C. to 30° C. is measured. The heat of crystallization during cooling stage is obtained from the area by integration of the peak interval of the baseline of a cooling crystallization curve measured using a differential scanning calorimeter (X° C. for poly(L-lactide) and poly(D-lactide)=220° C., X° C. for polylactide stereocomplex=250° C.)
3. Method for determining the degree of crystallization of polylactide:
   Using 10 milligrams of polylactide pellets as measured using a differential scanning calorimeter (an environment with nitrogen gas being passed through at a rate of 50 milliliters per minute), the temperature of the bead-shaped pellets is raised from 30° C. to Y° C. at a rate of 5° C./min., and the heat of crystallization (ΔHc) and heat of fusion (ΔHm) are measured when raising the temperature. The heat of crystallization (ΔHc) and the heat of fusion (ΔHm) when raising the temperature are obtained from the area by integration of the peak interval of the baseline of a temperature rise crystallization curve measured using a differential scanning calorimeter, and the degree of crystallization is calculated according to the following formula:

Degree of crystallization (%)=[(ΔHm−ΔHc)/ΔH0]×100%
ΔH0: Ideal heat of fusion of complete crystallization
(For poly(L-lactide) and poly(D-lactide) Y° C.=220° C., ΔH0=93 J/g; for polylactide stereocomplex Y° C.=250° C., ΔH0=142 J/g).
4. Method for measuring the water content (ppm) of polylactide pellets:

Immediately after the crystallization step, samples of the pellets for analysis are taken, and a Karl Fischer water Titrator is used under conditions of 60 ml/min of nitrogen gas, and a temperature of 150° C. for 30 minutes to measure the water content (ppm) of the pellets.
5. Inspection of the degree of agglomeration of the polylactide pellets:
   Visually inspect whether or not agglomeration is occurring between the polylactide pellets during the crystallization step.
   ⊚: Represents absolutely no agglomeration between pellets
   ∘: Represents slight agglomeration between pellets
   X: Represents a lot of agglomeration between pellets

### EXAMPLES AND COMPARATIVE EXAMPLES

### Example 1

Polymerizing a polylactide by a mixture containing 99.8% by weight of L-lactide and 0.2% by weight of other constituents, other constituents include D-lactide and/or Meso-lactide. The number-average molecular weight of such polylactide is 80,000. Extruding the polylactide through an extruder and forming a melt at a temperature of approximately 195° C. Carrying the melt to a die by a gear pump is fitted at a rear end of the extruder. An interior of the die is provided with a plurality of small holes. Extruding the melt from the small holes and enters the die-face cutting step. Both the outlet of the die and cutters are immersed in water, and the cutters being close to the outlet of the die. Continuously Cutting the extruded melt from the small holes into pellets. The die-face cutting step cutting of the melt to form the pellets in a warm water at a temperature of 70° C. Circulating the warm water at a circulating flow rate of 30 m³/hr to continuously flow in and out of the environment during the die-face cutting step, moreover, sending the pellets to the next step, dewatering step. The dewatering step is carried out using a centrifugal dryer in an atmosphere at a temperature of 105° C. (a thermometer is disposed at the outlet of the centrifugal dryer and is in direct contact with pellets for temperature measurement). Removing water under the condition of retention time is approximately 2 minutes. The degree of crystallization of the dried polymer is approximately 21%. The next step for dried polymer pellets is the crystallization step. The crystallization step is carried out in a silo bin, in an atmosphere at a temperature of 105° C.˜110° C. (the thermometers are disposed within silo bin, and the pellets are in direct contact with the thermometers). The pellets are fed into the upper portion of the silo bin. Controlling the temperature of pellets in an outlet of silo bin by a control valve disposed in the outlet of the lower portion of the silo bin. Retention time is approximately 10 minutes. After the crystallization step, the obtained polylactide pellets are inspected. The appearance of pellets has smooth surfaces with no concave. The heat of crystallization of the polylactide pellets released in cooling stage, as measured using a differential scanning calorimeter, is 46.5 J/g, and the degree of crystallization is approximately 50%. After the crystallization step, the water content of the pellets is approximately 120 ppm. During the crystallization step, the pellets do not agglomerate. Operating conditions of the manufacturing method and characteristic of the pellets are shown in Table 1.

### Examples 2˜4

The preparation of the bead-shaped polylactide pellets for Examples 2˜4 is the same as Example 1, and preparing pellets by different operating conditions as depicted in Table 1. The characteristics of the bead-shaped polylactide pellets prepared thereby are shown in Table 1.

### Example 5

The preparation of the bead-shaped polylactide pellets for Example 5 is similar to Example 1, but differs in polymerizing a polylactide by a mixture containing 99.5% by weight of D-lactide and 0.5% by weight of other constituents, such other constituents include L-lactide and/or Meso lactide. Preparing the bead-shaped polylactide pellets by different operating conditions as depicted in Table 1, and the characteristics of the bead-shaped polylactide pellets prepared thereby are depicted in Table 1.

### Example 6

The preparation of Example 6 is similar to Example 1, but differs in using 100% by weight of polylactide stereocomplex (formed by a mixture of 50% by weight of poly(L-lactide) from Example 1 and 50% by weight of poly(D-lactide) from Example 5). Preparing the bead-shaped polylactide pellets by different operating conditions as depicted in Table 1, and the characteristics of the bead-shaped polylactide pellets prepared thereby, are depicted in Table 1.

### Example 7

The preparation of Example 7 is similar to Example 1, but differs in polymerizing a polylactide by a mixture containing 99.5% by weight of L-lactide and 0.5% by weight of other constituents, such other constituents include D-lactide and/or Meso lactide. And then adding 1 part by weight of a crystal nucleating agent:zinc phenyl phosphate (relative to the 100 parts by weight of polylactide) to the extruder. Preparing the bead-shaped polylactide pellets by different operating conditions as depicted in Table 1, and the characteristics of the bead-shaped polylactide pellets prepared thereby are depicted in Table 1.

### Example 8

The preparation of Example 8 is similar to Example 1, but differs in polymerizing a polylactide by a mixture containing 96% by weight of L-lactide and 4% by weight of other constituents, such other constituents include D-lactide and/or Meso lactide. Preparing the bead-shaped polylactide pellets by different operating conditions as depicted in Table 1, and the characteristics of the bead-shaped polylactide pellets prepared thereby are depicted in Table 1. The heat of crystallization of the polylactide pellets released in the cooling stage is undetected by a differential scanning calorimeter (DSC). (Because of measurement limitations of the differential scanning calorimeter, undetected values are regarded as 0).

### Example 9

The preparation of Example 9 is similar to Example 1, but differs in polymerizing a polylactide by a mixture containing 90% by weight of L-lactide and 10% by weight of other constituents, such other constituents include D-lactide and/or Meso lactide. Preparing the bead-shaped polylactide pellets by different operating conditions as depicted in Table 1, and the characteristics of the bead-shaped polylactide pellets prepared thereby are depicted in Table 1. The heat of crystallization of the polylactide pellets released in the cooling stage is undetected by a differential scanning calorimeter (DSC). (Because of measurement limitations of the differential scanning calorimeter, undetected values are regarded as 0).

### Comparative Example 1

Polymerizing a polylactide by a mixture containing 98% by weight of L-lactide and 2% by weight of other constituents, other constituents include D-lactide and/or Meso-lactide. Extruding the polylactide through an extruder and forming a melt at a temperature of approximately 195° C. A gear pump fitted to a rear end of the extruder sending the melt to a die. An outlet of the die is provided with a plurality of small holes. After extruding the melt of polylactide from the die into strands, polymer strands pass through (are immersed in) a cooling water bath at a temperature of 10° C. After leaving the cooling water bath a part of water adhered on the strands is removed by blowers and the strands are pelletized by a pelletizer. And sending the pellets to the crystallization step. The crystallization step is carried out in a continuous fluidized bed, and because the temperature of the pellets is low, thus, the air supplied to the crystallization step must be heated using a heater before use thereof, and the procedure is carried out in an atmosphere at a temperature of 102˜108° C. (the thermometers are placed within the chamber, and jumping of the pellets causes them to come in direct contact with the thermometers) under conditions such that the retention time is 5 minutes. After the crystallization step, the polylactide pellets are of cylindrical-like, and it is observed that agglomeration of the pellets easily occurs in the crystallization step. The heat of crystallization of the polylactide pellets released in cooling stage, as measured by a differential scanning calorimeter, is 29 J/g, and the degree of crystallization of polylactide pellets is approximately 33%. Moreover, after the crystallization step, water content of the pellets is approximately 800 ppm. Operating conditions of the manufacturing method and the characteristics of the pellets are as depicted in Table 1.

### Comparative Example 2

The preparing method and conditions of Comparative Example 2 are similar to Example 3, however, changing the temperature of water in the die-face cutting step to 10° C., and the measured temperature in the centrifugal dewatering step is 30° C. Furthermore, because the temperature of the pellets is low, thus, when crystallization is carried out in an IR Drum, an infrared heater must be additionally actuated to supply a quantity of heat, thereby causing the atmosphere temperature in the crystallization step to reach 103˜107° C. After the crystallization step, the appearance of polylactide pellets is bead-shaped pellets, however, the surfaces thereof are uneven with concaves. The heat of crystallization of the polylactide pellets released in cooling stage, as measured by a differential scanning calorimeter, is 29 J/g, and the degree of crystallization of the polylactide pellets is approximately 35%. Moreover, after the crystallization step, water content of the pellets is approximately 600 ppm, and agglomeration of the pellets easily occurs during preparation. Operating conditions of the manufacturing method and the characteristics of the pellets are as depicted in Table 1.

### Comparative Example 3

The preparing method and conditions of Comparative Example 3 are similar to Example 4, however, changing the temperature of water in the die-face cutting step to 10° C., and the measured temperature in the centrifugal dewatering step is 30° C. Furthermore, because the temperature of the pellets is low, thus, when crystallization is carried out in a continuous fluidized bed, hot air must be blown in to supply a quantity of heat, thereby causing the atmosphere temperature in the crystallization step to reach 102˜108° C. After the crystallization step, the appearance of polylactide pellets is bead-shaped pellets, however, the surfaces thereof are uneven with concaves. The heat of crystallization of the polylactide pellets released in cooling stage, as measured by a differential scanning calorimeter, is 38 J/g, and the degree of crystallization of the polylactide pellets is approximately 45%. Moreover, after the crystallization step, water content of the pellets is approximately 420 ppm, and agglomeration of the pellets easily occurs during preparation. Operating conditions of the manufacturing method and the characteristics of the pellets are as depicted in Table 1.

### Comparative Example 4

The preparing method and conditions of Comparative Example 4 are similar to Example 8, however, changing the temperature of water in the die-face cutting step to 10° C., and the measured temperature in the centrifugal dewatering step is 30° C. Furthermore, because the temperature of the pellets is low, thus, when crystallization is carried out in a continuous fluidized bed, hot air must be additionally supplied to serve as a heat source, thereby causing the atmosphere temperature in the crystallization step to reach 102˜108° C. After the crystallization step, the appearance of polylactide pellets is bead-shaped pellets, however, the surfaces thereof are uneven with concaves. The heat of crystallization of the polylactide pellets released in the cooling stage is undetected by a differential scanning calorimeter (DSC). (Because of measurement limitations of the differential scanning calorimeter, undetected values are regarded as 0). The degree of crystallization of the polylactide pellets is approximately 16%. Moreover, after the crystallization step, water content of the pellets is approximately 400 ppm, and agglomeration of the pellets easily occurs during preparation. Operating conditions of the manufacturing method and the characteristics of the pellets are as depicted in Table 1.

### Comparative Example 5

The preparing method and conditions of Comparative Example 5 are similar to Example 3, however, changing the temperature of water in the die-face cutting step to 40° C., and the measured temperature in the centrifugal dewatering step is 60° C. Crystallization is carried out in an IR drum, and the atmosphere temperature in the crystallization step is 57˜63° C. After the crystallization step, the appearance of polylactide pellets is bead-shaped pellets, however, the surfaces thereof are uneven with concaves. The heat of crystallization of the polylactide pellets released in cooling stage, as measured by a differential scanning calorimeter, is 29 J/g, and the degree of crystallization of the polylactide pellets is approximately 6%. Moreover, after the crystallization step, water content of the pellets is approximately 1100 ppm. Operating conditions of the manufacturing method and the characteristics of the pellets are as depicted in Table 1.

### Comparative Example 6

The preparing method and conditions of Comparative Example 6 are similar to Example 3, however, changing the temperature of water in the die-face cutting step to 95° C., and the measured temperature in the centrifugal dewatering step is 135° C. Crystallization is carried out in an IR drum, and the atmosphere temperature in the crystallization step is 133° C.˜137° C. After the crystallization step, the appearance of polylactide pellets is bead-shaped pellets, however, the surfaces have no concaves. The heat of crystallization of the polylactide pellets released in cooling stage, as measured by a differential scanning calorimeter, is 29 J/g, and the degree of crystallization of the polylactide pellets is approximately 30%. Moreover, after the crystallization step, water content of the pellets is approximately 230 ppm, and agglomeration of the pellets easily occurs during preparation. Operating conditions of the manufacturing method and the characteristics of the pellets are as depicted in Table 1.

From the Comparative Example 1, it can be known that the polymer strands formed after extruding out a high temperature melt of 195° C. from the die. The polymer strands passing through a cooling water bath at a temperature of 10° C. and then raising the temperature to an atmosphere temperature of 102° C.˜108° C. in the crystallization step. The external appearance of the polylactide acid pellets obtained by such producing method is cylindrical-like. However, the problem of agglomeration frequently occurs during the crystallization step, making production difficult. In another aspect, the water content of the polylactide pellets is very high, and hydrolysis of the polylactide pellets easily occurs, thereby the requirement for further drying results in mass energy consumption. Moreover, the process of rapid cooling from the high temperature of melt to a low temperature and then raising the temperature again for the comparative example 1 results in mass energy consumption.

From the Comparative Examples 2˜4, die-face cutting at a water temperature of 10° C., dewatering at a temperature of 30° C., and crystallizing in an atmosphere temperature that is raised to 102˜108° C. Although the external appearance of the pellets obtained are in the form of bead-shaped pellets, however, the surfaces of the pellets are formed with concaves, and the problem of agglomeration easily occurs in the subsequent crystallization step, resulting in production difficulties. Moreover, water content of the polylactide pellets obtained after the crystallization step is very high, the polylactide pellets generally require further drying and resulting in mass consumption of energy resources. In addition, rapid cooling from the high temperature melt to a low temperature, and the requirement for additional actuation of an infrared heater or hot air to supply a quantity of heat during crystallization results in mass energy consumption.

The preparation of polylactide pellets for Comparative Example 5, die-face cutting at a water temperature of 40° C. (<50° C.), dewatering at a temperature of 60° C. (<80° C.), and crystallizing in an atmosphere at a temperature of 57° C.˜63° C. (<80° C.). The surfaces of pellets prepared thereof are formed with concaves. Moreover, the water content of the polylactide pellets obtained after the crystallization step is very high, generally requiring further drying of the polylactide acid pellets, resulting in mass consumption of energy resources.

The preparation of polylactide pellets for Comparative Example 6, die-face cutting in an underwater environment at a high temperature of 95° C. (>90° C.), dewatering at a temperature of 135° C., and crystallizing in an atmosphere at a temperature of 133° C.˜137° C., then the problem of agglomerate easily occurs in subsequent crystallization step, resulting in production difficulties.

From the Examples 1˜9, die-face cutting step is carried out with immersing the melt of polylactide in water at a temperature of 90° C.; dewatering in an atmosphere at a temperature between 80˜150° C.; and crystallizing in an atmosphere at a temperature between 80˜150° C. The obtained polylactide pellets have characteristics including preventing agglomeration from easily occurring, low water content, and smooth surfaces with no concaves. The manufacturing method of the present invention is thus able to achieve the objective of saving large amounts of energy resources.

TABLE 1
Examples & Comparative Examples of A Method for Producing Bead-Shaped Polylactide Pellets

| | | Example 1 | Example 2 | Example 3 | Example 4 | Example 5 | Example 6 | Example 7 | Example 8 |
|---|---|---|---|---|---|---|---|---|---|
| Lactide | LL-Lactide (% by weight) | 99.8 | 99.8 | 98.0 | 99.5 | — | — | 99.5 | 96.0 |
| Monomers | DD-Lactide + Meso | 0.2 | 0.2 | 2.0 | 0.5 | — | — | 0.5 | 4.0 |
| | Lactide (% by weight) | | | | | | | | |
| | DD-Lactide (% by weight) | — | — | — | — | 99.5 | — | — | — |
| | LL-Lactide + Meso | — | — | — | — | 0.5 | — | — | — |
| | Lactide (% by weight) | | | | | | | | |
| | Stereocomplex Polylactide | — | — | — | — | — | 100.0 | — | — |
| Nucleating Agent | (parts by weight) | — | — | — | — | — | — | 1.0 | — |
| Extruded Melt | (° C.) | 195.0 | 200.0 | 200.0 | 200.0 | 200.0 | 240.0 | 195.0 | 200.0 |
| Temperature | | | | | | | | | |
| Die-Face | Water Temperature (° C.) | 70.0 | 70.0 | 70.0 | 70.0 | 65.0 | 70.0 | 75.0 | 70.0 |
| Cutting Step | Amount of Water (m3/hr) | 30.0 | 26.0 | 30.0 | 30.0 | 30.0 | 30.0 | 30.0 | 30.0 |
| Dewatering | Polymer Temperature (° C.) | 105.0 | 105.0 | 115.0 | 105.0 | 105.0 | 130.0 | 110.0 | 105.0 |
| Step | Retention Time (min) | 2.0 | 2.0 | 2.0 | 2.0 | 2.5 | 2.0 | 2.0 | 2.0 |
| Crystallization | Apparatus | Silo Bin | Vibrating | IR Drum | Continuous | IR Drum | Continuous | IR Drum | Continuous |
| Step | | | Conveyor | | Fluidized | | Fluidized | | Fluidized |
| | | | | | Bed | | Bed | | Bed |
| | Polylactide Temperature | 105~110 | 103~108 | 113~117 | 102~108 | 103~107 | 127~133 | 108~112 | 102~108 |
| | (° C.) | | | | | | | | |
| | Retention Time (min) | 10 | 7 | 10 | 10 | 10 | 10 | 5 | 10 |
| Bead-Shaped | Heat of Crystallization (J/g) | 46.5 | 46.5 | 29 | 40.1 | 38 | 48 | 43.5 | ND |
| Polylactide | Degree of | 50 | 50 | 40 | 45 | 43 | 47 | 45 | 18 |
| Pellets | Crystallization (%) | | | | | | | | |
| | Water Content (ppm) | 120 | 210 | 210 | 150 | 100 | 170 | 210 | 150 |
| | Appearances | Bead- | Bead- | Bead- | Bead- | Bead- | Bead- | Bead- | Bead- |
| | | Shaped | Shaped | Shaped | Shaped | Shaped | Shaped | Shaped | Shaped |
| | Concave | ◯ | ◯ | ◯ | ◯ | ◯ | ◯ | ◯ | ◯ |
| | Agglomeration of Pellets | ⊚ | ⊚ | ⊚ | ⊚ | ⊚ | ⊚ | ⊚ | ◯ |

| | | | Comparative | Comparative | Comparative | Comparative | Comparative | Comparative |
|---|---|---|---|---|---|---|---|---|
| | | Example 9 | Example 1 | Example 2 | Example 3 | Example 4 | Example 5 | Example 6 |
| Lactide | LL-Lactide (% by weight) | 90.0 | 98.0 | 98.0 | 99.5 | 96.0 | 98.0 | 98.0 |
| Monomers | DD-Lactide + Meso | 10.0 | 2.0 | 2.0 | 0.5 | 4.0 | 2.0 | 2.0 |
| | Lactide (% by weight) | | | | | | | |
| | DD-Lactide (% by weight) | — | — | — | — | — | — | — |
| | LL-Lactide + Meso | — | — | — | — | — | — | — |
| | Lactide (% by weight) | | | | | | | |
| | Stereocomplex Polylactide | — | — | — | — | — | — | — |
| Nucleating Agent | (parts by weight) | — | — | — | — | — | — | — |
| Extruded Melt | (° C.) | 200.0 | 190.0 | 200.0 | 200.0 | 200.0 | 200.0 | 200.0 |
| Temperature | | | | | | | | |
| Die-Face | Water Temperature (° C.) | 70.0 | Cooling | 10.0 | 10.0 | 10.0 | 40.0 | 95.0 |
| Cutting Step | Amount of Water (m3/hr) | 26.0 | Water Bath | 30.0 | 30.0 | 30.0 | 26.0 | 30.0 |
| Dewatering | Polymer Temperature (° C.) | 105.0 | (10° C.) + | 30.0 | 30.0 | 30.0 | 60.0 | 135.0 |
| Step | Retention Time (min) | 2.0 | Pelletizer | 2.0 | 2.0 | 2.0 | 2.0 | 2.0 |
| Crystallization | Apparatus | IR Drum | Continuous | IR Drum | Continuous | Continuous | IR Drum | IR Drum |
| Step | | | Fluidized | | Fluidized | Fluidized | | |
| | | | Bed | | Bed | Bed | | |
| | Polylactide Temperature | 103~107 | 102~108 | 103~107 | 102~108 | 102~108 | 57~63 | 133~137 |
| | (° C.) | | | | | | | |
| | Retention Time (min) | 10 | 5 | 5 | 10 | 10 | 10 | 10 |
| Bead-Shaped | Heat of Crystallization (J/g) | ND | 29 | 29 | 38 | ND | 29 | 29 |
| Polylactide | Degree of | 0 | 33 | 35 | 45 | 16 | 6 | 30 |
| Pellets | Crystallization (%) | | | | | | | |
| | Water Content (ppm) | 120 | 800 | 600 | 420 | 400 | 1100 | 230 |
| | Appearances | Bead- | Cylindrical- | Bead- | Bead- | Bead- | Bead- | Bead- |
| | | Shaped | Like | Shaped | Shaped | Shaped | Shaped | Shaped |
| | Concave | ◯ | ◯ | X | X | X | X | ◯ |
| | Agglomeration of Pellets | ◯ | X | X | X | X | ◯ | X |

Notes:
1. Concave: ◯ represents that the appearances of the bead-shaped polylactide pellets have no concaves; X represents that the appearances of the bead-shaped polylactide pellets have concaves
2. Agglomeration of pellets: ⊚ represents absolutely no agglomeration of pellets; ◯ represents slight agglomeration of pellets; X represents agglomeration of many pellets
3. Heat of crystallization (J/g): the polylactide produced in the reduce temperature stage measured by DSC ND: represents the measurement limitations of the DSC, slow rate of crystallization
4. Nucleating agent: Zinc Phenylphosphonate
5. Water content: the water content of the bead-shaped polylactide pellets after the crystallization step

What is claimed is:

1. A method for producing a bead-shaped polylactide pellets, comprising a die-face cutting step, a dewatering step and a crystallization step, wherein:
the die-face cutting step is carried out by immersing the melt of polylactide under water at a temperature of 50˜90° C.;
the dewatering step is carried out in an atmosphere at a temperature between 80˜150° C.;
the crystallization step is carried out in an atmosphere at a temperature between 80˜150° C.;
the bead-shaped pellets finally obtained have a water content of 10˜400 ppm; and
the bead-shaped pellets have smooth surfaces with no concaves.

2. The method for producing a bead-shaped polylactide pellets according to claim 1, wherein the die-face cutting step is carried out under water at a temperature of 55˜85° C., the dewatering step is carried out in an atmosphere at a temperature between 90˜130° C., and the crystallization step is carried out in an atmosphere at a temperature between 90˜140° C.

3. The method for producing a bead-shaped polylactide pellets according to claim 1, wherein the dewatering step is carried out using a dewatering device including centrifugal dryer.

4. The method for producing a bead-shaped polylactide pellets according to claim 1, wherein the crystallization step is carried out in an atmosphere at a temperature between 100˜130° C.

5. The method for producing a bead-shaped polylactide pellets according to claim 1, wherein the crystallization step is carried out in a vibrating conveyor.

6. The method for producing a bead-shaped polylactide pellets according to claim 1, wherein the crystallization step is carried out in a continuous fluidized bed.

7. The method for producing a bead-shaped polylactide pellets according to claim 1, wherein the crystallization step is carried out in an IR Drum.

8. The method for producing a bead-shaped polylactide pellets according to claim 1, wherein the crystallization step is carried out in a silo bin.

9. The method for producing a bead-shaped polylactide pellets according to claim 1, wherein a nucleating agents are further added prior to melting the polylactide in an amount of between 0.1˜10 parts by weight, based on 100 parts by weight of the polylactide.

10. A bead-shaped polylactide pellets prepared from the method according to claim 1.

11. The bead-shaped polylactide pellets according to claim 10, wherein a heat of crystallization of the polylactide is ≧0 J/g and <2 J/g and the degree of crystallization is ≧1% and <30%, as measured using a differential scanning calorimeter.

12. The bead-shaped polylactide pellets according to claim 10, wherein a heat of crystallization of the polylactide is 2˜60 J/g and the degree of crystallization is 30%˜60%, as measured using a differential scanning calorimeter.

13. The bead-shaped polylactide pellets according to claim 10, wherein the polylactide is prepared by polymerization of 100% by weight of starting material monomers containing 97˜99.95% by weight of L-lactide.

14. The bead-shaped polylactide pellets according to claim 13, wherein the polylactide is prepared by polymerization of 100% by weight of starting material monomers containing 99˜99.95% by weight of L-lactide.

15. The bead-shaped polylactide pellets according to claim 12, wherein the polylactide is prepared by polymerization of 100% by weight of starting material monomers containing 99˜99.95% by weight of D-lactide.

16. The bead-shaped polylactide pellets according to claim 12, wherein the polylactide is a stereocomplex polylactide composed of 30˜95 wt % poly(L-lactide) and 70˜5 wt % poly(D-lactide).

17. The bead-shaped polylactide pellets according to claim 11, wherein the crystallization step is carried out in a silo bin.

18. A bead-shaped polylactide pellets have a water content of 10˜400 ppm and have smooth surfaces with no concaves.

19. The bead-shaped polylactide pellets according to claim 18, wherein a heat of crystallization of the polylactide, as measured using a differential scanning calorimeter, is ≧0 J/g and <2 J/g, and the degree of crystallinity is ≧1% and <30%.

20. A bead-shaped polylactide pellets according to claim 18, wherein a heat of crystallization of the polylactide, as measured using a differential scanning calorimeter, is 2˜60 μg, and the degree of crystallinity is 30%˜60%.
